(19) United States
(12) Patent Application Publication
(10) Pub. No.: US 2009/0218273 A1
(43) Pub. Date: Sep. 3, 2009

(54) Filter Fluid Capture Device

(76) Inventors: Troy Thomas Pummill, Soquel, CA (US); Matthew W Gawlowski, Woodland Park, CO (US)

Correspondence Address: TROY THOMAS PUMMILL, 2900 MAPLETHORPE LANE, SOQUEL, CA, 95073, US

(21) Appl. No.: 12/393,199

(22) Filed: Feb. 26, 2009

Related U.S. Application Data
(60) Provisional application No. 61/033,025, filed on Mar. 3, 2008.

(51) Int. Cl. B01D 35/00

(52) U.S. Cl. 210/248

(57) ABSTRACT

A method for managing fluids spilled from a filter. The Filter Fluid Capture Device slides onto a filter creating a fluid-tight seal that prevents fluids from leaking to the bottom of the filter. A reservoir created between the walls of the Filter Fluid Capture Device and the filter capture and hold any fluid that are spilled from the filter during removal or installation of the filter.

### CROSS-REFERENCE TO RELATED APPLICATION

The present application claims priority to U.S. Provisional Application No. 61/033,025, filed on Mar. 3, 2008, which is incorporated herein by reference.

### BACKGROUND OF THE INVENTION

Canister filters are employed in a wide variety of applications from auto engines to manufacturing equipment. These filters work by passing a liquid substance through a medium that removes debris and/or impurities.

As the filter collects debris and/or impurities, the ability of the filter to perform its function is diminished. A filter requires replacement when the filter medium becomes saturated.

Replacement of a canister filter typically involves removal of the filter from a filter mounting. A new filter is replaced into the filter mounting and thus restores the ability to remove debris and impurities from the liquid substance.

As many filter mountings are down-facing, the fluid remaining inside the filter has a tendency to spill from of the top of the filter and run down the side of the canister filter during the replacement process. This spilled liquid can make the side the canister filter slippery (thus increasing the effort required to remove the filter). Oil-based, as well as many other fluids, are slippery, potentially hazardous, and possibly extremely hot. If the filter is removed by hand (as is typical), the spilled fluid may come into contact with the skin. Any fluid that reaches the ground may pose a threat to the environment by contaminating the soil or water sources as surface run-off.

Thus, there is a need in the art for a device to capture fluid spilled from a canister filter during replacement. It is therefore an object of the present invention to provide a device that attaches to a canister filter that restricts the fluid from dripping down or off the canister, coming into contact with the person replacing the filter, or from reaching the ground.

### BRIEF SUMMARY OF THE INVENTION

A method for managing fluid spilled from a filter during filter removal or installation. The Filter Fluid Capture Device captures fluid which is spilled from a canister filter thereby keeping the fluid from dripping off the filter or coming in to contact with the person replacing the filter.

The Filter Fluid Capture Device is installed onto the canister filter by sliding up from the bottom of the filter. The Filter Fluid Capture Device is designed to fit snugly around the circumference of a filter. With the Filter Fluid Capture Device installed on a filter, the Filter Fluid Capture forms a cup or reservoir between the wall of the filter and the Filter Fluid Capture Device. This reservoir contains any spilled fluid by preventing the spilled fluid from leaking past the bottom of the Filter Fluid Capture Device where it meets the filter. The Filter Fluid Capture Device captures spilled fluid into a reservoir during removal or installation of the canister filter.

After the filter is removed, the contents of the capture reservoir can be poured safely into a proper storage container. After emptying, the Filter Fluid Capture Device might be removed and cleaned for re-use. It is also possible that the Filter Fluid Capture Device might be designed for single use and may be discarded with the spent filter. It would also be possible to integrate the Filter Fluid Capture Device into the filter itself so that the filter would essentially have two walls—an inside wall that contains the filter itself and an outside wall that forms a reservoir between the inside and outside walls.

### BRIEF DESCRIPTION OF THE DRAWINGS

FIG. 1 is a diagram from the top of the Filter Fluid Capture Device.

FIG. 2 is a side view of the Filter Fluid Capture Device installed onto a filter

FIG. 3 is a bottom view of the Filter Fluid Capture Device installed onto a filter.

FIG. 4 is a top view of the Filter Fluid Capture Device (labeled 2) installed onto a filter (labeled 1). The fluid-containing reservoir is labeled 4

FIG. 5 Is a cross section of the filter and Filter Fluid Capture Device when installed. The filter is labeled 1. The Filter Fluid Capture Device is labeled 2. The area where the filter and the Fluid Filter Capture Device meet is labeled 3. The reservoir space is labeled 4.

FIG. 6 is a diagram from the top of Filter Fluid Capture Device which employs an integrated o-ring.

FIG. 7 Is a cross section of the filter and Filter Fluid Capture Device with o-ring when installed. The filter is labeled 1. The Filter Fluid Capture Device is labeled 2. The area where the filter and the Fluid Filter Capture Device meet is labeled 3. The reservoir space is labeled 4. The integrated o-ring is labeled 5.

FIG. 8 is the diagram of the bottom view of the Filter Fluid Capture Device when installed onto a filter.

FIG. 9 is a diagram depicting the separated filter (labeled 1) and the Filter Fluid Capture Device (labeled 2).

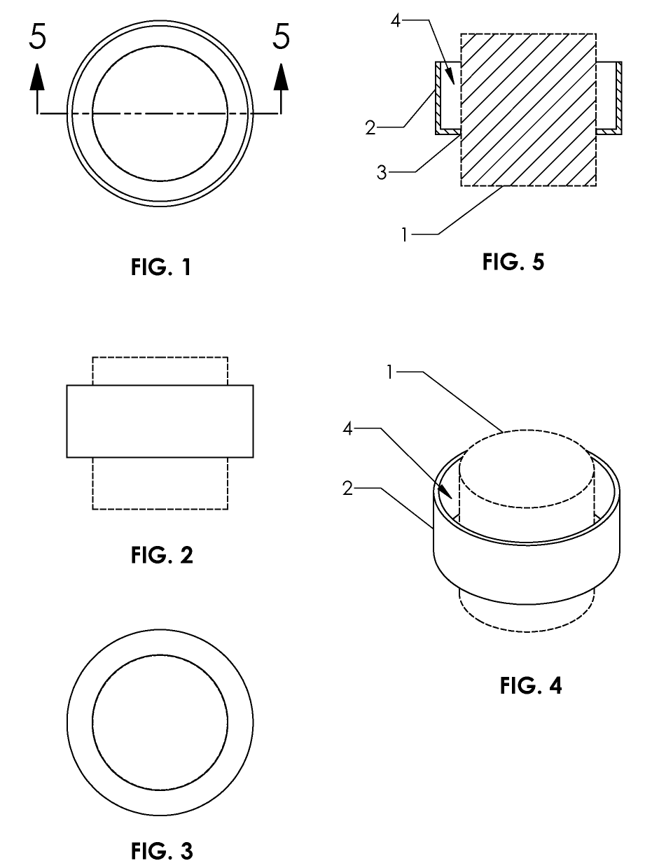

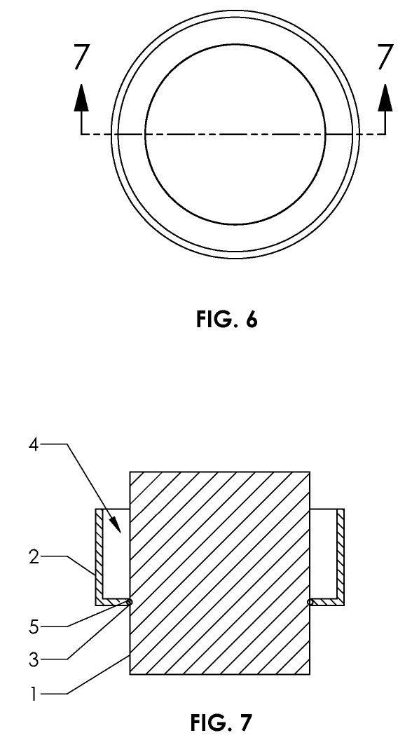

### DETAILED DESCRIPTION OF THE INVENTION

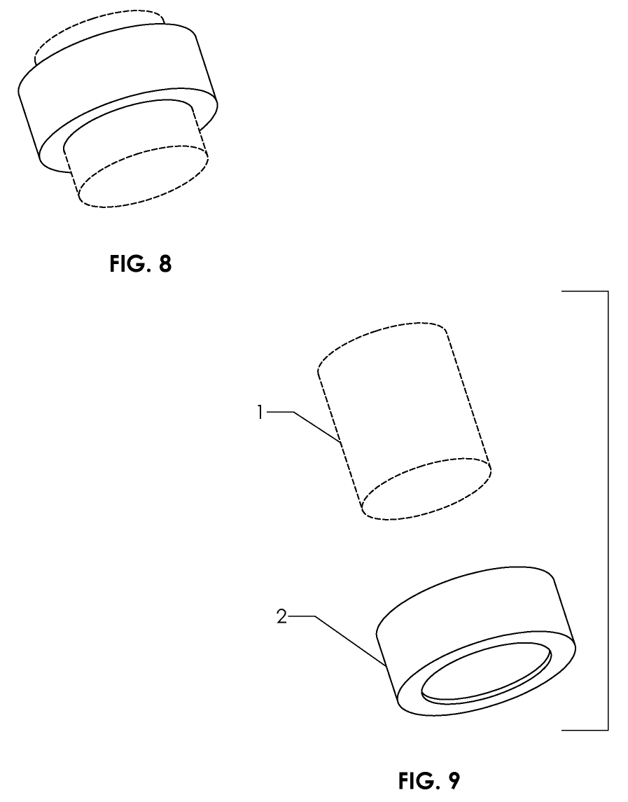

FIG. 9 shows a Filter Fluid Capture Device (2) and the filter (1). The Filter Fluid Capture Device is typically applied to a filter by sliding the Filter Fluid Capture Device onto the filter from the bottom. The Filter Fluid Capture Device fits onto the filter as in FIG. 8. The edge of the Filter Fluid Capture Device mates to the filter as in FIGS. 5 and 7 and creates a seal at the point where the Filter Fluid Capture Device and filter meet (labeled 3 in FIGS. 5 and 7). The seal may be created solely by the material from which the Filter Fluid Capture Device is comprised, or it may be created by some other device, such as the integrated o-ring shown in FIG. 7, label 5. Of course, those skilled in the relevant art may employ other types of seals without departing from the spirit of the present invention.

When mated with a filter, the Filter Fluid Capture Device creates a reservoir area (displayed in FIGS. 4, 5 and 7, label 4) wherein fluid spilled from the filter is contained. The containment created by the seal between the filter and Filter Fluid Capture Device prevents spilled fluid from leaking beyond the seal point (FIGS. 5 and 7, label 3) and reaching the side of the filter canister (FIG. 7, label 1). The outer wall of the filter and the inner wall of the Filter Fluid Capture Device create the reservoir area (FIGS. 4, 5 and 7, label 4)

Anyone knowledgeable in the art might conceive a Filter Fluid Capture Device which is manufactured into the filter itself without departing from the spirit of the present invention.

What is claimed is:

1. A method for managing fluid spilled from a filter comprising a Filter Fluid Capture Device which mates with a filter to form a fluid-tight seal to create a reservoir between the wall of the Filter Fluid Capture Device and the filter.

2. A method of claim 1 further comprising a seal created by the Filter Fluid Capture Device itself

3. A method of claim 1 further comprising a seal created by a separate device such as a o-ring.

4. A method of claim 1 further comprising of holding fluids spilled from the filter within a reservoir.
